(19) United States
(12) Patent Application Publication
(10) Pub. No.: US 2026/0044736 A1
(43) Pub. Date: Feb. 12, 2026

(54) NEURAL NETWORK SYSTEM USING MULTI FORMAT DATA AND METHOD OF OPERATING THE SAME

(71) Applicants: SK hynix Inc., Gyeonggi-do (KR); Seoul National University R&DB Foundation, Seoul (KR)

(72) Inventors: Woohyeon BAEK, Seoul (KR); Jonghyun BAE, Seoul (KR); Yeonhong PARK, Seoul (KR); Jaewook LEE, Seoul (KR)

(21) Appl. No.: 19/038,891

(22) Filed: Jan. 28, 2025

(30) Foreign Application Priority Data
Aug. 12, 2024 (KR) 10-2024-0107911

(51) Int. Cl. G06N 3/082

(52) U.S. Cl. CPC G06N 3/082

(57) ABSTRACT

A neural network system includes a storage configured to store a data set including a plurality of encoded data and a plurality of raw data; a profile circuit configured to determine a format ratio of the plurality of encoded data to the plurality of raw data; a data control circuit configured to generate a mini batch used for a neural network learning operation based on the data set stored in the storage; and a learning control circuit configured to provide a request for generating the mini batch to the data control circuit while controlling the neural network learning operation.

### CROSS-REFERENCE TO RELATED APPLICATION

The present application claims priority under 35 U.S.C. § 119(a) to Korean Patent Application No. 10-2024-0107911, filed on Aug. 12, 2024, which is incorporated herein by reference in its entirety.

### BACKGROUND

### 1. Technical Field

Embodiments of the present disclosure relate to a neural network system that improves performance thereof by using various formats of data.

### 2. Related Art

Deep neural networks (DNNs) are used in various visual analysis tasks and systems due to their high accuracy. Modern DNNs are computationally intensive, and hardware accelerators such as graphics processing units (GPUs) and tensor processing units (TPUs) are commonly used to train these models.

The input image is prepared on the host device such as a central processing unit (CPU) and used for training operations.

The DNN training pipeline includes three stages: an image loading stage, an image decoding stage, and a gradient calculation stage.

The input image is first retrieved from a storage and decoded in a host memory.

The decoded data is transferred to the training device such as a GPU, a TPU, and etc. to calculate the gradient.

Ideally, the time to perform each pipeline stage should be evenly distributed to achieve maximum training throughput.

Recent hardware accelerators have significantly reduced the gradient calculation time thereof, however, the time spent on data preparation stages such as, the image loading stage and the image decoding stage has increased, which is a bottleneck for performance improvement.

### SUMMARY

In accordance with an embodiment of the present disclosure, a neural network system may include a storage configured to store a data set including a plurality of encoded data and a plurality of raw data; a profile circuit configured to determine a format ratio of the plurality of encoded data to the plurality of raw data; a data control circuit configured to generate a mini batch used for a neural network learning operation based on the data set stored in the storage; and a learning control circuit configured to provide a request for generating the mini batch to the data control circuit while controlling the neural network learning operation.

In accordance with an embodiment of the present disclosure, a method of operating a neural network system may include storing a data set including a plurality of encoded data and a plurality of raw data; determining a format ratio of the plurality of encoded data to the plurality of raw data; generating a mini batch used for a neural network learning operation based on the stored data set; and issuing a request for generating the mini batch while controlling the neural network learning operation.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and describe various principles and advantages of those embodiments.

FIG. 1 illustrates a neural network system according to an embodiment of the present disclosure.

FIG. 2 illustrates an operation of a profile circuit according to an embodiment of the present disclosure.

FIG. 3 illustrates a data control circuit according to an embodiment of the present disclosure.

FIG. 4 illustrates an operation of a data control circuit according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

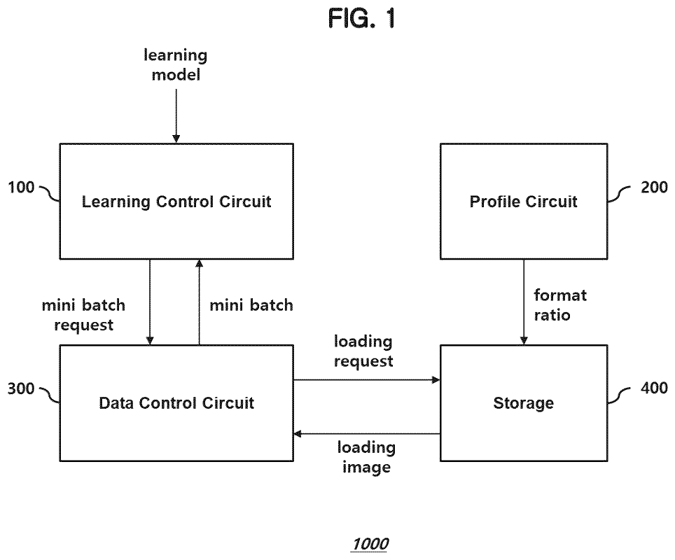

FIG. 1 is a block diagram showing a neural network system 1000 according to one embodiment of the present disclosure.

The neural network system 1000 may include a learning control circuit 100, a profile circuit 200, a data control circuit 300, and a storage 400.

The learning control circuit 100 may control an overall learning operation for the neural network system according to a learning model.

During the learning process, the learning control circuit 100 may provide a mini batch request to the data control circuit 300, and the data control circuit 300 may generate and provide a mini batch to the learning control circuit 100, and a learning control circuit 100 may perform a learning operation using the mini batch.

The profile circuit 200 may determine an optimal format ratio corresponding to an image set stored in the storage 400 in a given learning environment.

The profile circuit 200 may measure a decoding throughput and a loading throughput for an image, and the profile circuit 200 may determine an optimal format ratio using the measured information, which will be described in detail later.

Hereinafter, a format may indicate a format of an image file, such as PNG, JPG, etc., and a format ratio may indicate a ratio of each format included in the image set.

In this embodiment, an image set may be divided into an encoded image and a raw image.

The encoded image may indicate an image in which each pixel data thereof is encoded in a predetermined format, and a raw image may indicate an image in which each pixel data thereof is not encoded.

For example, each of PNG and JPG images may correspond to an encoded image, and a BMP image may correspond to a raw image.

More specifically, a PNG image may be a lossless encoded image, which requires a lot of resources for decoding, but requires relatively less resources for loading from a disk. The CPU may be used more than the GPU during decoding.

A JPG image may be a lossy encoded image, which requires relatively more resources for decoding, but requires relatively less resources for loading from a disk. The GPU may be used more than the CPU during decoding.

A BMP image may be a raw image, which requires relatively less resources for decoding, but requires relatively more resources for loading from a disk.

The profile circuit 200 may adjust a current format ratio by referring to a current loading throughput and a current decoding throughput, and adjust a ratio of encoded images and raw images in an image set stored in the storage 400 accordingly.

The profile circuit 200 may use a binary search technique to determine the optimal format ratio.

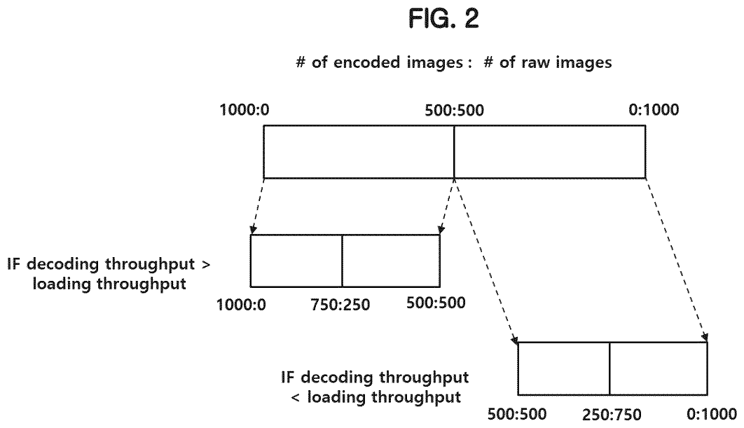

FIG. 2 is a diagram illustrating a binary search technique used by the profile circuit 200 according to an embodiment of the present disclosure.

Hereinafter, as an example, the image set stored in the storage 400 includes a total of 1000 images.

The raw image has a large file size but does not require a decoding operation. Accordingly, the higher the raw image ratio, the lower the throughput of the loading operation and the higher the throughput of the decoding operation.

Conversely, the lower the raw image ratio, the higher the throughput of the loading operation and the lower the throughput of the decoding operation.

First, a search space for searching the optimal format ratio is initialized.

In this embodiment, the initial search space is from 1000:0, when only encoded images are included, to 0:1000, when only raw images are included.

Next, the current format ratio is initialized to 500:500, which is the middle point of the search space.

Next, the image set of the storage 400 is generated according to the current format ratio.

The profile circuit 200 may measure the throughput of the loading operation and the throughput of the decoding operation for the image set.

In this embodiment, the throughput of the loading operation and the throughput of the decoding operation are measured for the entire image set of 1000 images.

However, a partial sample image set including, for example, 200 out of 1000 images, may be set and the throughput of the loading operation and the throughput of the decoding operation may be measured using the partial sample image set. At this time, the partial sample image set needs to include the number of encoded images and raw images corresponding to the current format ratio.

The throughput of the loading operation and the throughput of decoding operation may be measured by generating the partial sample image set only once, but the throughput of the loading operation and the throughput of the decoding operation may be determined by generating the partial sample image set multiple times and measuring averages thereof.

Afterwards, the throughput of the decoding operation and the throughput of the loading operation are compared with each other to adjust the search space and to update the current format ratio accordingly.

For example, if the throughput of the decoding operation is greater than the throughput of the loading operation, which means that the loading operation is taking more time, a ratio of the encoded images needs to be increased.

In this case, the search space is updated to a range from 1000:0 to 500:500, and the current format ratio is modified to 750:250, which is the midpoint of the search space.

Conversely, if the throughput of the loading operation is greater than the throughput of the decoding operation, which means that the decoding operation is taking more time, a ratio of the raw images needs to be increased.

In this case, the search space is updated to a range from 500:500 to 0:1000, and the current format ratio is modified to 250:750, which is the midpoint of the search space.

The above operation is repeated until the current format ratio converges to a certain value, and the converged value can be determined as the optimal format ratio.

The criteria for determining whether the format ratio has converged can be changed in various ways depending on the embodiment.

When the optimal format ratio is determined, the storage 400 may store the encoded images and the raw images according to the optimal format ratio.

In this embodiment, each format of the encoded image and format of the raw image may be determined as a specific one in advance.

In another embodiment, the encoded images may include various formats selected from a PNG format, a JPG format, and other formats for encoded images, and the raw images may include various formats selected from a BMP format and other formats for raw images.

The operation of determining the optimal format ratio in the profile circuit 200 is a type of preprocessing operation that is performed before performing a learning operation after the image set is prepared, and therefore does not affect the real-time learning performance.

The data control circuit 300 may generate a mini batch according to a mini batch request requested by the learning control circuit 100 during the learning process. That is, the data control circuit 300 may affect the real-time learning performance.

The data control circuit 300 may transmit an image loading request to the storage 400 and receive a loading image during the mini batch generation process.

At this time, frequent random read operations may occur in the storage 400, but the storage 400 generally has a problem of low random read performance.

The data control circuit 300 can reduce the impact on real-time learning performance by distributing image loading operations performed with the storage 400 to the entire mini batch generation processes that are performed during the learning process.

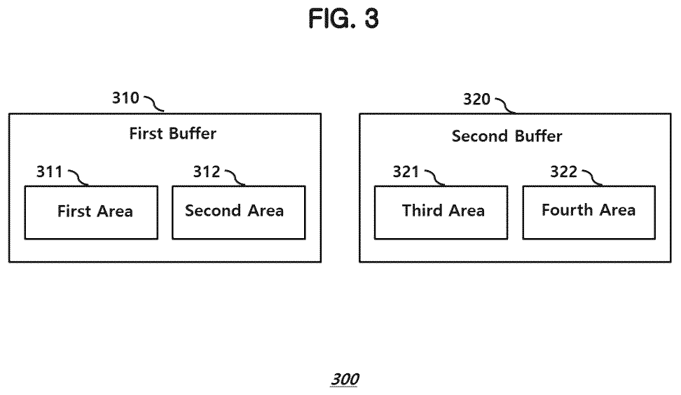

FIG. 3 is a block diagram illustrating the data control circuit 300 according to an embodiment of the present disclosure.

The data control circuit 300 may generate (i.e., issue) and provide a mini batch according to a mini batch request provided by the learning control circuit 100.

In this embodiment, as an example, the mini batch includes 100 images and 10 mini batches are generated during each epoch of the learning operation.

In this embodiment, the data control circuit 300 may include a first buffer 310 for storing encoded images and a second buffer 320 for storing raw images.

The first buffer 310 may be referred to as an encoded image buffer, and the second buffer 320 may be referred to as a raw image buffer.

The data control circuit 300 may use the first buffer 310 and the second buffer 320 to maintain a desired format ratio in generating a mini batch and to ensure a constant time for generating a mini batch in each epoch.

In this embodiment, as an example, the first buffer 310 and the second buffer 320 store a total of 500 images.

In addition, the first buffer 310 and the second buffer 320 may be divided into an area for storing images required to generate a mini-batch of the current epoch and an area for storing images required to generate a mini batch of the next epoch, respectively.

That is, the first buffer 310 may include a first area 311 for the current epoch and a second area 312 for the next epoch, and the second buffer 320 may include a third area 321 for the current epoch and a fourth area 322 for the next epoch.

At the beginning of the operation, the data control circuit 300 may sequentially read the storage 400 and store the encoded image in the first area 311 of the first buffer 310 and the raw image in the third area 321 of the second buffer 320.

For example, the optimal format ratio of the encoded image and the raw image determined by the profile circuit 200 is 4:1.

At this time, the first area 311 of the first buffer 310 may store 400 images, and the third area 321 of the second buffer 320 may store 100 images.

The storage 400 may be in a state where it stores a plurality of encoded images and a plurality of raw images according to the optimal format ratio determined through the operation of the profile circuit 200.

In this embodiment, as an example, multiple encoded images and multiple raw images are alternately stored according to the optimal format ratio in order to maintain the optimal format ratio even during the sequential reading process.

For example, if the optimal format ratio of the encoded image and the raw image is 4:1, the storage 400 is configured so that four encoded images and one raw image are sequentially stored every five files.

Through this, the time required to find the next encoded image and raw image to be read can be reduced.

The profile circuit 200 can change the format of the stored files in the above manner in consideration of the sequential reading while reconfiguring the storage 400 according to the current format ratio.

In order to sequentially read the encoded image and the raw image, the storage 400 can manage the encoded image pointer and the raw image pointer that indicate the next encoded image and raw image to be read.

In this embodiment, since each mini batch includes 100 images, 10 mini batches are generated for each epoch.

The data control circuit 300 may randomly select an image from the current areas of the first buffer 310 and the second buffer 320 according to the optimal format ratio when generating a mini batch.

In this embodiment, to configure a mini batch according to a predetermined probability, the currently selected image is controlled to be used in the next epoch or discarded after use.

Hereinafter, the operation of controlling the use in the next epoch is referred to as a migration operation, and the operation of discarding after use is referred to as an eviction operation.

In the migration operation, the selected image may be migrated from the current area to the next area of the corresponding buffer.

In the eviction operation, the selected image may be evicted from the current area of the corresponding buffer, and the next image of the corresponding format may be read from the storage 400 and stored in the location where the evicted image was stored in the current area.

In this embodiment, each of the migration operation and the eviction operation have a probability of 50%.

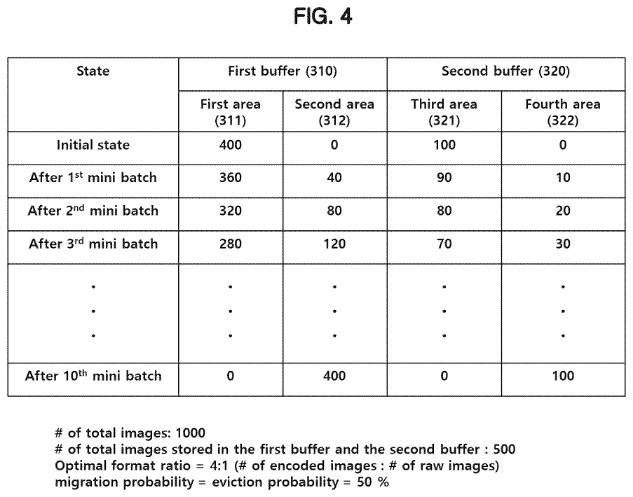

FIG. 4 is a diagram showing an operation of the data control circuit 300 according to an embodiment of the present disclosure.

In this embodiment, the storage 400 may store 1,000 images, and the optimal format ratio of the encoded image and the raw image may be 4:1.

Accordingly, the data control circuit 300 may store 400 images in the first area 311 of the first buffer 310 at the beginning of the operation, and store 100 images in the third area 321 of the second buffer 320.

As aforementioned, the size of the mini batch is 100, and the migration probability and the eviction probability are both 50%.

The data control circuit 300 may randomly select 80 images from the first buffer 310 in the process of generating a mini batch. At this time, the number of images evicted from the first 311 of the first buffer 310 and the number of images migrated to the second area 312 of the first buffer 310 may be 40, respectively.

In addition, the data control circuit 300 may randomly select 20 images from the second buffer 320 in the process of generating a mini batch. At this time, the images that are evicted from the third area 321 of the second buffer 320 and the images that are migrated to the fourth area 322 may be 10, respectively.

As aforementioned, the data control circuit 300 may sequentially read the encoded images from the storage 400 instead of the encoded images evicted from the first area 311 of the first buffer 310 and store them in the first buffer 310, and sequentially store the images that are migrated from the first area 311 of the first buffer 310 in the second area 312.

In addition, the data control circuit 300 may sequentially read the raw images from the storage 400 instead of the raw images that are evicted from the third area 321 of the second buffer 320 and store them in the second buffer 320, and sequentially store the images that are migrated from the third area 321 of the second buffer 320 in the fourth area 322.

When operating according to these rules, after generating the first mini batch as shown in FIG. 4, the first area 311 of the first buffer 310 may store 360 images, the second area 312 may store 40 images, the third area 321 of the second buffer 320 may store 90 images, and the fourth area 322 may store 10 images.

In the same way, after generating the 10th mini batch, the first area 311 of the first buffer 310 may store 0 images, and the second area 312 may store 400 images, the third area 321 of the second buffer 320 may store 0 images, and the fourth area 322 may store 100 images.

To generate a mini batch in the next epoch, the current and next areas of the first buffer 310 and the second buffer 320 may be swapped.

That is, the first area 311 in the current epoch becomes the second area 312 in the next epoch, and the second area 312 in the current epoch becomes the first area 311 in the next epoch.

In addition, the third area 321 in the current epoch becomes the fourth area 322 in the next epoch, and the fourth area 322 in the current epoch becomes the third area 321 in the next epoch.

Through this, the data control circuit 300 can evenly distribute the time required to load data from the storage 400 during the real-time learning operation to the entire learning operation.

In addition, the efficiency of the pipeline operation can be improved by evenly distributing the decoding time and the loading time for each mini batch according to the optimal format ratio.

In the above disclosure, an embodiment of determining a format ratio of an encoded image to a raw image in a neural network system that performs learning using images and generating a mini batch in real time using the format ratio was disclosed.

However, a type of data need not be limited to image data, and it is apparent that this technology can be applied to a neural network system that performs a learning operation using encoded data and raw data that does not require decoding.

Although various embodiments have been illustrated and described, various changes and modifications may be made to the described embodiments without departing from the spirit and scope of the invention as defined by the following claims. Furthermore, the embodiments may be combined to form additional embodiments.

What is claimed is:

1. A neural network system comprising:
a storage configured to store a data set including a plurality of encoded data and a plurality of raw data;
a profile circuit configured to determine a format ratio of the plurality of encoded data to the plurality of raw data;
a data control circuit configured to generate a mini batch used for a neural network learning operation based on the data set stored in the storage; and
a learning control circuit configured to provide a request for generating the mini batch to the data control circuit while controlling the neural network learning operation.

2. The neural network system of claim 1, wherein the profile circuit is configured to set a current format ratio in a search space, and control the storage to store the plurality of encoded data and the plurality of raw data corresponding to the current format ratio.

3. The neural network system of claim 2, wherein the profile circuit is configured to measure a decoding throughput and a loading throughput corresponding to the current format ratio, and adjust the search space and the current format ratio according to the decoding throughput and the loading throughput while controlling an operation of reading a plurality of sample data from the storage and decoding the plurality of sample data.

4. The neural network system of claim 1,
wherein the data control circuit includes:
a first buffer configured to store encoded data; and
a second buffer configured to store raw data,
wherein the data control circuit is configured to store part of the data set stored in the storage in the first buffer and the second buffer, and
wherein numbers of data stored in the first buffer and the second buffer correspond to the current format ratio.

5. The neural network system of claim 4, wherein the data control circuit is configured to:
read the storage sequentially; and
store encoded data in a first area of the first buffer, and store raw data in a third area of the second buffer.

6. The neural network system of claim 5, wherein the data control circuit is configured to randomly select a plurality of encoded data from the first area, and randomly select a plurality of raw data from the third area according to the format ratio to generate the mini batch.

7. The neural network system of claim 6, wherein the data control circuit is configured to:
migrate selected encoded data with a predetermined probability to a second area included in the first buffer, or evict the selected encoded data from the first area when selecting encoded data from the first area; and
migrate the selected raw data with a predetermined probability to the fourth area included in the second buffer, or evict the selected raw data from the third area when selecting raw data from the third area.

8. The neural network system of claim 7, wherein the data control circuit is configured to:
read new encoded data from the storage, and store the new encoded data in a location of evicted encoded data from the first area when evicting the encoded data from the first area; and
read new raw data from the storage, and store the new raw data in the location of evicted raw data from the third area when evicting the raw data from the third area.

9. The neural network system of claim 7, wherein, when the first area and the third area become vacant, the data control circuit is configured to swap the first area and the second area, and swap the third area and the fourth area.

10. A method of operating a neural network system, the method comprising:
storing a data set including a plurality of encoded data and a plurality of raw data;
determining a format ratio of the plurality of encoded data to the plurality of raw data;
generating a mini batch used for a neural network learning operation based on the stored data set; and
issuing a request for generating the mini batch while controlling the neural network learning operation.
